(19) United States
(12) Patent Application Publication
(10) Pub. No.: US 2022/0309371 A1
(43) Pub. Date: Sep. 29, 2022

(54) AUTOMATED QUANTUM CIRCUIT JOB SUBMISSION AND STATUS DETERMINATION

(71) Applicant: Red Hat, Inc., Raleigh, NC (US)

(72) Inventors: Parul Singh, Boston, MA (US); Jonathan H. Cope, Austin, TX (US); Jeffrey H. Vance, Sunnyvale, CA (US); Huamin Chen, Westford, MA (US)

(21) Appl. No.: 17/216,505

(22) Filed: Mar. 29, 2021

(51) Int. Cl. G06N 10/00; G06F 15/16

(52) U.S. Cl. CPC G06N 10/00; G06F 15/16

(57) ABSTRACT

Automated quantum circuit job submission and status determination is disclosed. A classical computing system receives a request to execute a quantum circuit that includes quantum program instructions that perform one or more quantum operations on one or more qubits. The classical computing system requests, from a first quantum computing system that includes a first set of quantum computing devices, metadata describing characteristics of the first set of quantum computing devices. The classical computing system determines, based on the quantum circuit and the metadata, a selected quantum computing device of the first set of quantum computing devices, and sends, to the first quantum computing system, quantum circuit information that identifies the quantum circuit and instructions to execute the quantum circuit on the selected quantum computing device.

### BACKGROUND

A quantum computing device can solve certain types of problems substantially quicker than a classical computing device. Quantum computing devices are a finite resource, and a quantum computing provider may offer quantum computing resources to users on a shared basis. Consequently, there may be a delay between submitting a quantum circuit job to a quantum computing provider for execution, and the actual execution of the quantum circuit job due to a queue of other quantum circuit jobs awaiting execution.

### SUMMARY

The examples disclosed herein implement automated quantum circuit job submission and status determination.

In one example a method is provided. The method includes receiving, by a classical computing system comprising one or more classical computing devices comprising one or more processor devices, a request to execute a quantum circuit that includes quantum program instructions that perform one or more quantum operations on one or more qubits. The method further includes requesting, by the classical computing system from a first quantum computing system comprising a first set of quantum computing devices, metadata describing characteristics of the first set of quantum computing devices. The method further includes determining, by the classical computing system, based on the quantum circuit and the metadata, a selected quantum computing device of the first set of quantum computing devices. The method further includes sending, to the first quantum computing system, quantum circuit information that identifies the quantum circuit and instructions to execute the quantum circuit on the selected quantum computing device.

In another example a computing system is provided. The computing system includes one or more classical computing devices including one or more processor devices. The one or more processor devices are to receive a request to execute a quantum circuit that includes quantum program instructions that perform one or more quantum operations on one or more qubits. The one or more processor devices are further to request, from a first quantum computing system comprising a first set of quantum computing devices, metadata describing characteristics of the first set of quantum computing devices. The one or more processor devices are further to determine, based on the quantum circuit and the metadata, a selected quantum computing device of the first set of quantum computing devices. The one or more processor devices are further to send, to the first quantum computing system, quantum circuit information that identifies the quantum circuit and instructions to execute the quantum circuit on the selected quantum computing device.

In another example a non-transitory computer-readable storage medium is provided. The non-transitory computer-readable storage medium includes executable instructions to cause one or more processor devices to receive a request to execute a quantum circuit that includes quantum program instructions that perform one or more quantum operations on one or more qubits. The instructions further cause the one or more processor devices to request, from a first quantum computing system comprising a first set of quantum computing devices, metadata describing characteristics of the first set of quantum computing devices. The instructions further cause the one or more processor devices to determine, based on the quantum circuit and the metadata, a selected quantum computing device of the first set of quantum computing devices. The instructions further cause the one or more processor devices to send, to the first quantum computing system, quantum circuit information that identifies the quantum circuit and instructions to execute the quantum circuit on the selected quantum computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1B are block diagrams of an environment at different points in time in which examples may be practiced;

FIG. 2 is a flowchart of a method for automated quantum circuit job submission and status determination according to one implementation;

FIGS. 3A-3B are block diagrams of an environment at different points in time in which additional examples may be practiced;

FIGS. 4A-4B are block diagrams of an environment at different points in time in which additional examples may be practiced;

FIG. 5 is a block diagram of a computing device suitable for implementing aspects illustrated in FIGS. 1A-1B according to one implementation;

FIG. 6 is a block diagram of a computing device according to additional implementations;

FIG. 7 is a simplified block diagram of the environment illustrated in FIGS. 1A-1B according to one implementation; and

FIG. 8 is a block diagram of a computing device suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

A quantum computing device can solve certain types of problems substantially quicker than a classical computing device. Quantum computing devices are a finite resource, and a quantum computing provider may offer quantum computing resources to users on a shared basis. Consequently, there may be a delay between submitting a quantum circuit job to a quantum computing provider for execution, and the actual execution of the quantum circuit job due to a queue of other quantum circuit jobs awaiting execution.

A quantum circuit comprises quantum program instructions that perform one or more quantum operations on one or more qubits. The term “quantum circuit job” as used herein refers to the metadata associated with the execution of a quantum circuit on a quantum computing device. A quantum circuit job may include, for example, a job identifier to uniquely identify the quantum circuit job from other quantum circuit jobs that are currently executing, have executed, or are to be executed in the future, as well as a status at any particular moment in time. The quantum circuit job corresponds to a particular quantum circuit to be executed and may be said to include the quantum circuit or a quantum circuit identifier that identifies a location of the quantum circuit. The precise particulars of a quantum circuit job are system dependent based on how a quantum circuit job is implemented by any particular quantum computing device provider; however, as used herein, the term refers to a particular quantum circuit to be executed and a status, such as queued, executing, finished, and the like.

Submission of a quantum circuit job to a quantum computing device provider, sometimes referred to as a quantum backend, may require specialized knowledge specific to each quantum backend, such as how to generate program instructions for communicating with the interface of each quantum backend, the format of information submitted to the quantum backend, the format of responses from the quantum backend, and the like. Moreover, determining which quantum computing devices in a quantum backend have the capabilities sufficient to execute a particular quantum circuit, such as a quantum computing device that implements a sufficient number of qubits, can require specialized querying of the quantum backend, so that the quantum circuit job can be directed to a particular quantum computing device. Some quantum computing devices may have a long queue of quantum circuit jobs and others may not, and, if it is desirable to have the quantum circuit job executed as quickly as possible, additional querying regarding the quantum circuit job queues of the quantum computing devices may be desirable. A quantum backend may store information when a quantum circuit job has completed, but the requestor may have to periodically submit a status request to the quantum backend to determine whether or not the quantum circuit job has completed, and thus, the requestor may not receive the results of the execution of the quantum circuit job until a substantial period of time after the quantum circuit job has completed.

The examples disclosed herein implement automated quantum circuit job submission and status determination. A user, or an application, sends a request to a classical computing system to execute a quantum circuit. The classical computing system obtains metadata describing characteristics of a set of quantum computing devices implemented by a quantum computing system. Based on the quantum circuit and the metadata, the classical computing system selects a particular quantum computing device of the set of quantum computing devices, and sends, to the quantum computing system, quantum circuit information that identifies the quantum circuit and instructions to execute the quantum circuit on the selected quantum computing device. The classical computing system may periodically, or according to a schedule, poll the quantum computing system to obtain a current job status associated with the execution of the quantum circuit. The classical computing system may store the current job status, and automatically provide updates regarding the job status to the requestor or provide the current job status to the requestor when asked to do so.

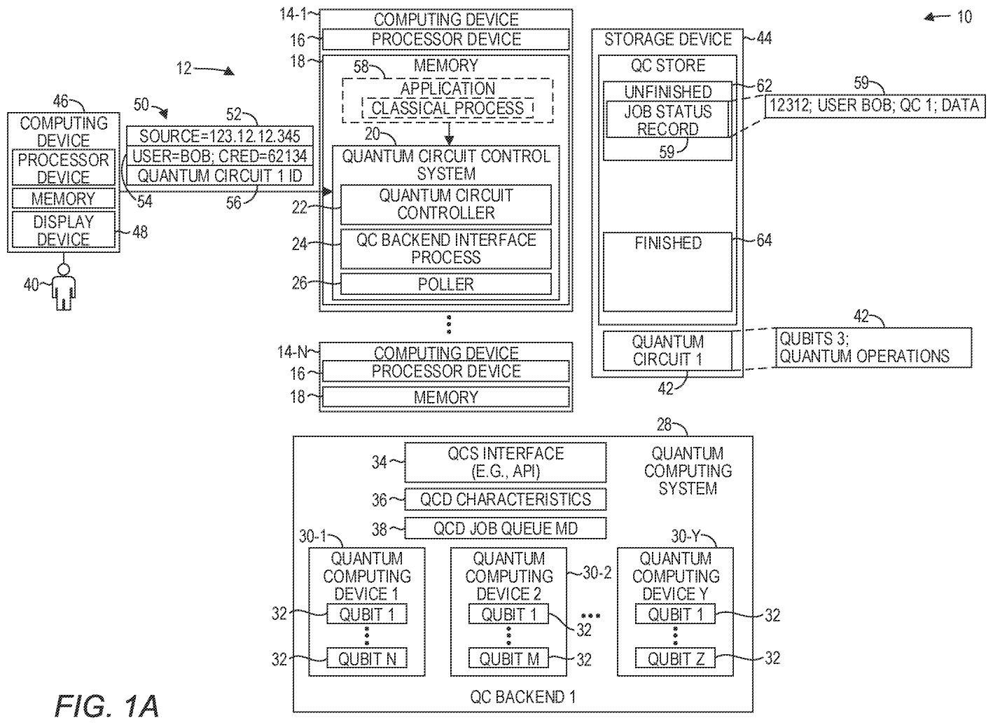

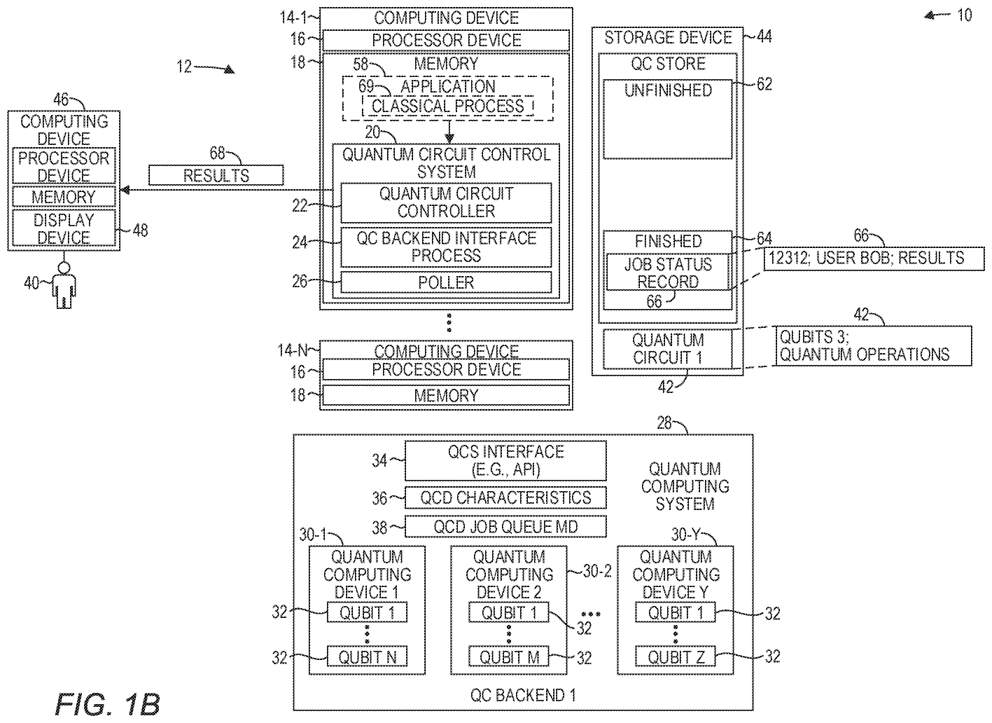

FIGS. 1A-1B are block diagrams of an environment 10 at different points in time in which examples may be practiced. Referring first to FIG. 1A, the environment 10 includes a classical computing system 12, which includes a plurality of computing devices 14-1-14-N (generally, computing devices 14). Each of the computing devices 14 have one or more processor devices 16, and a memory 18. The term “classical computing device” as used herein refers to a computing device that operates using binary values (e.g., zero and one).

The computing device 14-1 includes a quantum circuit control system 20, which, in this implementation, includes three components, a quantum circuit (QC) controller 22, a QC backend interface process 24, and a poller 26. While solely for purposes of illustration the quantum circuit control system 20 is illustrated as being implemented on a single computing device 14-1, in practice, the components of the quantum circuit control system 20 may be distributed among any number of the computing devices 14-1-14-N and communicate with each other via a network (not illustrated), as suitable to implement the functionality disclosed herein. In some implementations, the quantum circuit control system 20 may be containerized, and each of the components may be embodied as a separate container, which, in accordance with a particular container orchestration system, may each be initiated on a different computing device 14, or one or more of the components may be initiated on the same computing device 14.

The environment 10 includes a quantum computing system 28, sometimes referred to as a quantum computing “backend”. The quantum computing system 28 may be geographically close or distant from the classical computing system 12 and may be operated by the same or a different entity than that which operates the classical computing system 12. The quantum computing system 28 includes a plurality of quantum computing devices 30-1-30-Y (generally, quantum computing devices 30). The quantum computing devices 30 operate in a quantum environment but can operate using classical computing principles or quantum computing principles. When using quantum computing principles, the quantum computing devices 30 perform computations that utilize quantum-mechanical phenomena, such as superposition and entanglement. The quantum computing devices 30 may operate under certain environmental conditions, such as at or near 0° Kelvin.

The quantum computing devices 30 process quantum program instructions and perform quantum operations on qubits 32 in accordance with the quantum program instructions. The quantum computing devices 30 may implement different numbers of qubits 32.

The quantum computing system 28 includes a quantum computing system (QCS) interface 34. The QCS interface 34 allows classical computing devices, such as the computing devices 14, to submit quantum circuits to the quantum computing system 28 for execution on a quantum computing device 30. The QCS interface 34 has a defined protocol and may be implemented, for example, as an application programming interface (API).

The quantum computing system 28 also maintains metadata about the quantum computing devices 30 that may be accessed by a computing device 14 via the QCS interface 34. As an example, the quantum computing system 28 maintains metadata, in the form of quantum computing device (QCD) characteristics 36, that identifies characteristics of the quantum computing devices 30, such as the number of qubits 32 implemented by each quantum computing device 30. The quantum computing system 28 also maintains metadata in the form of QCD job queue metadata 38 that includes a real time count of the quantum circuit jobs that are currently queued to be executed by each quantum computing device 30.

In this example, the quantum computing system 28 operates to receive a request via the QCS interface 34 to execute a quantum circuit on a designated quantum computing device 30. The quantum computing system 28 generates a quantum circuit job that includes a job identifier (ID), and can provide, upon a request via the QCS interface 34, a current status of the execution of the quantum circuit job. Such statuses may include, by way of non-limiting example, queued for execution, executing, and/or completed. When a quantum circuit job is completed, the quantum computing system 28 may store the results of the quantum circuit and can provide the results when requested via the QCS interface 34.

To illustrate automated quantum circuit job submission and status determination in accordance with one implementation, assume that a user 40 (sometimes referred to as a requestor) desires to have a quantum circuit 42, which the user 40 has stored on a storage device 44, executed for testing purposes. The user 40 interacts via a computing device 46 with the quantum circuit controller 22. In one implementation, the quantum circuit controller 22 may communicate with the computing device 46 to cause a user interface to be presented on a display device 48. The user 40 sends to the quantum circuit controller 22, via the user interface, a request 50 to execute the quantum circuit 42, which includes quantum program instructions that perform one or more quantum operations on one or more qubits. In this example, the request 50 includes a source ID 52, in this example an IP address of the computing device 46, credentials 54 that authenticate the user 40 with the quantum computing system 28, and a quantum circuit identifier 56, which is a reference to the location of the quantum circuit 42 stored on the storage device 44.

It should be noted that the request 50 is merely one example of such a request, and the request 50 may take any of many different forms and may contain additional, or different information than that illustrated in FIG. 1A. For example, in some implementations, the quantum computing system 28 may not require credentials. In some implementations, the request 50 may include the actual quantum program instructions that make up the quantum circuit to be executed, in lieu of a reference to a location of the quantum circuit to be executed. Moreover, it is further noted that the quantum circuit controller 22 may also accept programmatic requests from an application, such as an application 58, executing on one of the computing devices 14. In such implementations, the application 58 formats a request in a particular protocol, such as in accordance with an API implemented by the quantum circuit controller 22, to have a quantum circuit executed.

The quantum circuit controller 22 receives the request 50. In some implementations, the quantum circuit controller 22 may analyze the quantum circuit 42 to determine a number of qubits 32 that will be utilized by the quantum circuit 42. In some implementations, this information may be included in the request 50. The QC backend interface process 24 invokes one or more entry points, such as methods, of the QCS interface 34 to request the QCD characteristics 36 and the QCD job queue metadata 38 from the quantum computing system 28. The QC backend interface process 24, in this example, uses the QCD characteristics 36 to determine which quantum computing devices 30 implement a number of qubits 32 equal to or greater than the number of qubits to be utilized by the quantum circuit 42. The QC backend interface process 24 then accesses the QCD job queue metadata 38 to determine, for each of such quantum computing devices 30, the number of quantum circuit jobs queued to be executed by the quantum computing devices 30. The QC backend interface process 24 may then select a particular quantum computing device 30 that implements a sufficient number of qubits 32 and that has a shortest quantum circuit job queue. In this example, for purposes of illustration, it will be assumed that the QC backend interface process 24 selected the quantum computing device 30-1.

The QC backend interface process 24 sends to the quantum computing system 28, via the QCS interface 34, quantum circuit information that identifies the quantum circuit 42 and instructions to execute the quantum circuit 42 on the quantum computing device 30-1. The quantum circuit information may identify the quantum circuit 42 by including the quantum circuit 42, or by providing a reference to the location of the quantum circuit 42 on the storage device 44. The QC backend interface process 24 may also provide the credentials 54 in conjunction with the quantum circuit information and the instructions to authenticate the user 40 with the quantum computing system 28.

The QC backend interface process 24 receives, via the QCS interface 34, initial job status metadata associated with the quantum circuit 42. The initial job status metadata may comprise, for example, a job ID and a current status, such as queued, executing, or the like. If queued, the initial job status metadata may identify the particular spot in the quantum circuit job queue of the quantum circuit job. If the credentials 54 were not successful in authenticating the user 40 with the quantum computing system 28, an initial job status record 59 may indicate that the request to execute the quantum circuit 42 failed due to authentication reasons. The QC backend interface process 24 stores the initial job status record 59 containing metadata from the initial job status metadata in a storage device, such as the storage device 44.

In this example, the quantum circuit control system 20 maintains two different job status “buckets”, or categories. An unfinished bucket 62 maintains the job statuses of quantum circuit jobs that have not yet completed, and a finished bucket 64 maintains the job statuses of quantum circuit jobs that have completed.

At any point in time, a requestor, such as the user 40, or the application 58, may issue a quantum circuit status request to the quantum circuit controller 22 to obtain the current status of the quantum circuit job that corresponds to a request to execute a quantum circuit. In response, the quantum circuit controller 22 may access the storage device 44 and locate the current job status record that corresponds to the quantum circuit. The quantum circuit controller 22 may then send information to the requestor that identifies the job status of the quantum circuit based on the job status record that corresponds to the quantum circuit.

Periodically, intermittently, and/or in accordance with a schedule, a poller 26 may access the unfinished bucket 62 and, for each quantum circuit job in the unfinished bucket 62, issue a request to the quantum computing system 28 via the QCS interface 34 for an updated job status. The quantum computing system 28 receives the request(s) and provides, for each respective quantum circuit job, updated job status metadata. The poller 26 stores an updated job status record that contains metadata from the updated job status metadata in the storage device 44 in lieu of the previous job status record.

Referring now to FIG. 1B, at a subsequent point in time, the poller 26 issues a request to the quantum computing system 28 via the QCS interface 34 for an updated job status of the quantum circuit job that corresponds to the quantum circuit 42. The quantum computing system 28 receives the request and provides updated job status metadata that indicates that the quantum circuit job has completed. The poller 26 deletes the job status record 59 (FIG. 1A) and adds a job status record 66 to the finished bucket 64. The updated job status metadata may also include the results of the execution of the quantum circuit 42, and the poller 26 stores such results in the job status record 66. In some implementations, the quantum circuit control system 20 may proactively send results 68 to the requestor that contain the results of the execution of the quantum circuit 42.

While for purposes of illustration this example has focused solely on the execution of the quantum circuit 42, the examples also implement an ability for an application to integrate classical processing with quantum processing. As an example, the application 58 may facilitate both classical computations implemented on one of the computing devices 14, as well as quantum computations implemented via the quantum computing system 28. For example, the application 58 may involve certain computations that are performed equally fast or faster on a classical computing device than a quantum computing device and may also involve computations that are performed faster on a quantum computing device than a classical computing device.

In one implementation, the application 58 may initiate a classical process 69 to perform certain classical computations on the computing device 14-1. At some point in the processing, the classical process 69 generates an output value and pauses. The application 58 may then formulate a request to the quantum circuit controller 22 to have the quantum circuit 42 executed by the quantum computing system 28, as discussed above. The application 58 may first modify the quantum circuit 42 to include the output value generated by the classical process 69. After the quantum circuit 42 is executed on the quantum computing system 28, the quantum circuit controller 22 may provide the results 68 to the application 58. In other implementations, the application 58 may periodically poll the quantum circuit controller 22 to determine whether the quantum circuit 42 has executed, and if so, obtain the results 68. The application 58 then provides the results 68 to the classical process 69, and the classical process 69 continues processing using the results 68. In this manner, the examples facilitate automated and seamless integration of both classical computations and quantum computations, with no human involvement.

While for purposes of illustration only one quantum computing backend, the quantum computing system 28, is depicted, in practice, the quantum circuit control system 20 may be able to communicate with multiple different quantum computing backends, each of which may be operated by a different entity. Moreover, each of such different quantum computing backends may have a unique and different API for communicating with the quantum computing backend, and thus, the quantum circuit control system 20 must utilize different interfaces to interact with the different quantum computing backends.

It is noted that, solely for purposes of illustration, the quantum circuit control system 20 has been described as implementing functionality through particular components, such as the quantum circuit controller 22, the QC backend interface process 24, and the poller 26. However, it will be appreciated that the novel functionality implemented by such components could be implemented using any number of components, including a number smaller or greater than three, and the examples are not limited to the particular components, or number of components, disclosed herein.

Moreover, the quantum circuit control system 20 includes one or more components of the computing device 14-1, and functionality implemented by the quantum circuit control system 20 may be attributed to the computing device 14-1 generally. Moreover, in examples where the quantum circuit control system 20 comprises software instructions that program the processor device 16 to carry out functionality discussed herein, functionality implemented by the quantum circuit control system 20 may be attributed herein to the processor device 16.

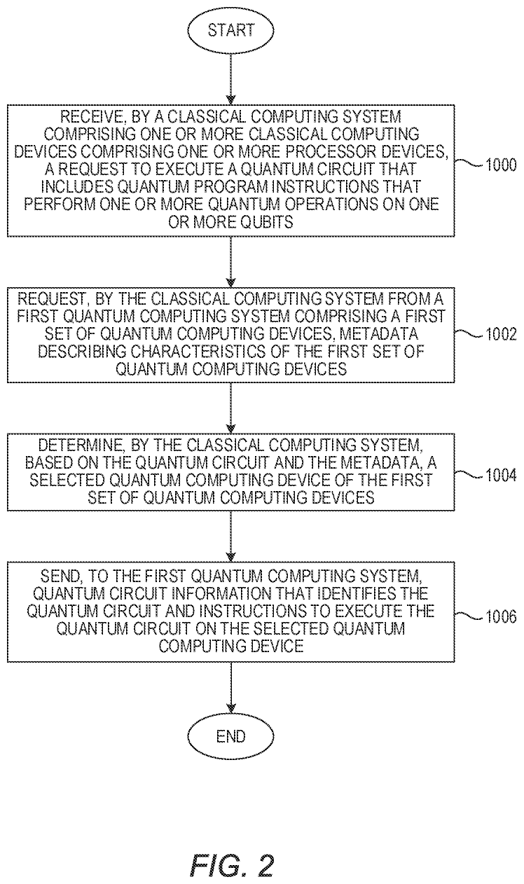

FIG. 2 is a flowchart of a method for automated quantum circuit job submission and status determination according to one implementation. FIG. 2 will be discussed in conjunction with FIGS. 1A-1B. The classical computing system 12, including the one or more classical computing devices 14-1-14-N comprising the one or more processor devices 16, receives the request 50 to execute the quantum circuit 42 that includes quantum program instructions that perform one or more quantum operations on one or more qubits (FIG. 2, block 1000). The classical computing system 12 requests, from the quantum computing system 28 comprising the set of quantum computing devices 30-1-30-Y, metadata describing characteristics of the set of quantum computing devices 30-1-30-Y (FIG. 2, block 1002). The classical computing system 12 determines, based on the quantum circuit 42 and the metadata, a selected quantum computing device 30-1 of the set of quantum computing devices 30-1-30-Y (FIG. 2, block 1004). The classical computing system 12 sends, to the quantum computing system 28, quantum circuit information that identifies the quantum circuit 42 and instructions to execute the quantum circuit 42 on the selected quantum computing device 30-1 (FIG. 2, block 1006).

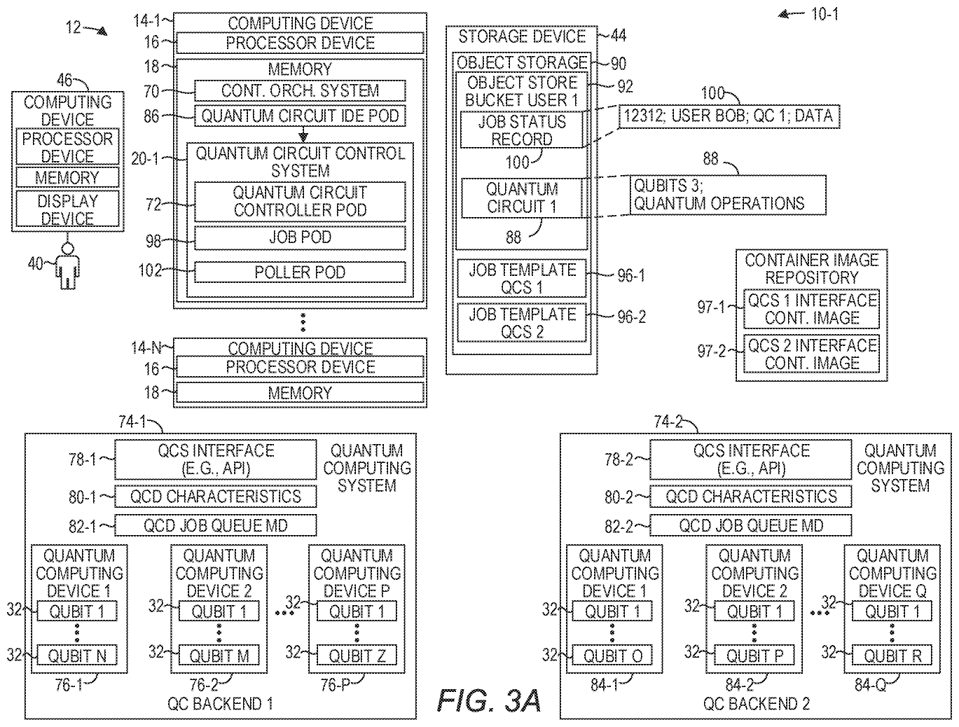

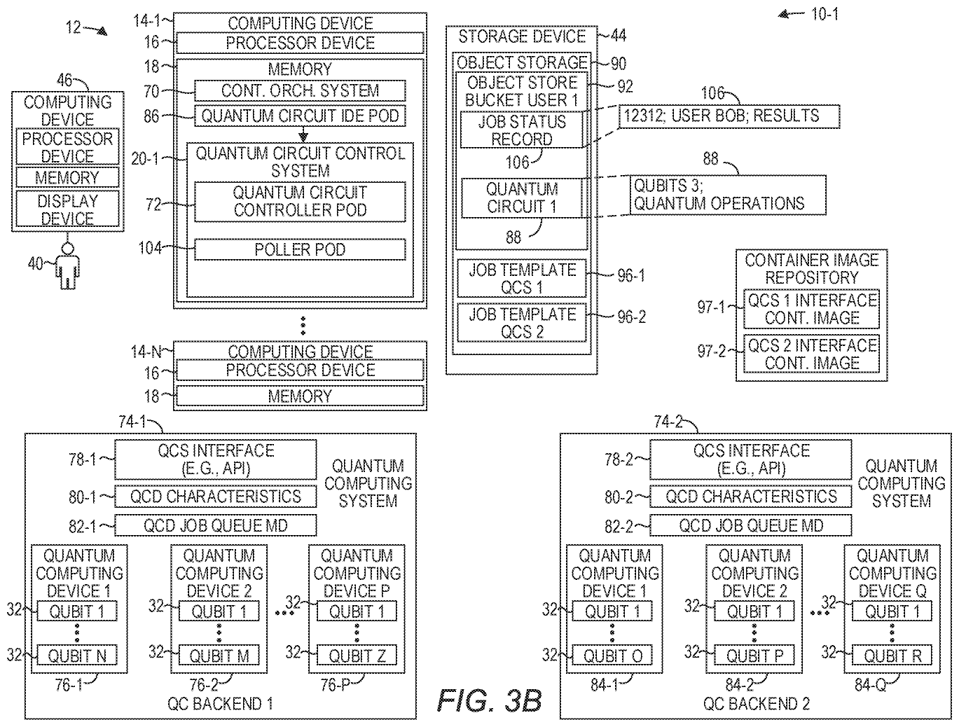

FIGS. 3A-3B are block diagrams of an environment 10-1 in which additional examples may be practiced, at different points in time. The environment 10-1 is substantially similar to the environment 10 except as otherwise discussed herein. The environment 10-1 includes the plurality of computing devices 14-1-14-N. The computing devices 14 each include one or more processor devices 16, and a memory 18. In this implementation, processes executing on the computing devices 14 are managed by a container orchestration system 70, such as, by way of non-limiting example, a Kubernetes container orchestration system. The container orchestration system 70 initiates functional processes in the form of containers onto computing devices of a cluster of computer devices. In some implementations, the Kubernetes container orchestration system may be a Red Hat® OpenShift® enterprise-ready Kubernetes container platform with full-stack automated operations to manage hybrid cloud, multi-cloud, and edge deployments.

The phrase “container” as used herein refers to Linux containers wherein the Linux kernel uses namespaces to isolate processes from one another. The phrase “container image” as used herein refers to a static package of software comprising one or more layers, the layers including everything needed to run an application (i.e., as a container) that corresponds to the container image, including, for example, one or more of executable runtime code, system tools, system libraries, and configuration settings. A Docker® image is an example of a container image.

In this example, the container orchestration system 70 implements containers via pods. A pod is a logical entity that can isolate one or more containers in a pod from one or more containers in another pod. A pod is defined via a pod specification or template which includes information such as an identification of the containers in the pod, the volumes used by the containers in the pod, and the like. Thus, throughout the figures, where a pod is depicted, the functionality of the pod is implemented via the one or more containers identified in the pod specification that corresponds to the pod. The computing device 14-1 includes a quantum circuit control system 20-1, which, in this implementation, includes a quantum circuit controller pod 72.

The environment 10-1 includes a first quantum computing backend in the form of a quantum computing system 74-1 and a second quantum computing backend in the form of a quantum computing system 74-2. The quantum computing systems 74-1 and 74-2 may be operated by two different quantum service providers. The quantum computing system 74-1 includes a plurality of quantum computing devices 76-1-76-P (generally, quantum computing devices 76), each of which process quantum program instructions and perform quantum operations on qubits 32 in accordance with the quantum program instructions. The quantum computing devices 76 may implement different numbers of qubits 32.

The quantum computing system 74-1 includes a QCS interface 78-1. The QCS interface 78-1 allows classical computing devices, such as the computing devices 14, to submit quantum circuits to the quantum computing system 74-1 for execution on a quantum computing device 76. The QCS interface 78-1 has a defined protocol and may be implemented, for example, as an API.

The quantum computing system 74-1 also maintains metadata about the quantum computing devices 76 that may be accessed by a computing device 14 via the QCS interface 78-1. As an example, the quantum computing system 74-1 maintains metadata in the form of QCD characteristics 80-1 that identifies characteristics of the quantum computing devices 76, such as the number of qubits 32 implemented by each quantum computing device 76. The quantum computing system 74-1 also maintains metadata, in the form of QCD job queues 82-1, that includes a real-time counter of the quantum circuit jobs that are currently queued to be executed by each quantum computing device 76.

The quantum computing system 74-2 includes a plurality of quantum computing devices 84-1-84-Q (generally, quantum computing devices 84), each of which process quantum program instructions and perform quantum operations on qubits 32 in accordance with the quantum program instructions. The quantum computing devices 84 may implement different numbers of qubits 32.

The quantum computing system 74-2 includes a QCS interface 78-2. The QCS interface 78-2 allows classical computing devices, such as the computing devices 14, to submit quantum circuits to the quantum computing system 74-2 for execution on a quantum computing device 84. The QCS interface 78-2 has a defined protocol that differs from that of the QCS interface 78-1, and may be implemented, for example, as an API.

The quantum computing system 74-2 also maintains metadata about the quantum computing devices 84 that may be accessed by a computing device 14 via the QCS interface 78-2. As an example, the quantum computing system 74-2 maintains metadata, in the form of QCD characteristics 80-2, that identifies characteristics of the quantum computing devices 84, such as the number of qubits 32 implemented by each quantum computing device 84. The quantum computing system 74-2 also maintains metadata, in the form of QCD job queues 82-2, that includes a real-time counter of the quantum circuit jobs that are currently queued to be executed by each quantum computing device 84.

To illustrate automated quantum circuit job submission and status determination in accordance with this implementation, the user 40 interacts with a quantum circuit (QC) interactive development environment (IDE) pod 86 to generate a quantum circuit 88. In some examples, the user 40 may first provide login credentials to the QC IDE pod 86 that serve to authenticate the user 40 and to identify the user 40. In this implementation, the environment 10-1 utilizes an object storage 90 to store information. The QC IDE pod 86 may generate an object store bucket 92 that requires certain authentication credentials to access. The user 40 generates quantum program instructions via the QC IDE pod 86 and, when finished, stores the quantum program instructions as a quantum circuit 88 in the object store bucket 92. Any suitable QC IDE pod 86 may be utilized. In some implementations, the QC IDE pod 86 is a Jupyter Notebook pod (jupyter.org), modified as disclosed herein utilizing the Qiskit service (qiskit.org), and the user 40 defines the quantum circuit 88 in a Jupyter notebook.

The user 40 may then send a request via the QC IDE pod 86 to the quantum circuit controller pod 72 to execute the quantum circuit 88, which includes quantum program instructions that perform one or more quantum operations on one or more qubits. The request may include a reference to the quantum circuit 88 and the authentication credentials associated with the object store bucket 92, as well as credentials that authenticate the user 40 with the quantum computing system 74-1 or 74-2, or both. In some implementations, the quantum circuit controller pod 72 implements a representational state transfer (REST) API interface, and the user 40 makes the request via the REST API interface.

The quantum circuit controller pod 72 receives the request. In some implementations, the quantum circuit controller pod 72 may analyze the quantum circuit 88 to determine a number of qubits 32 that will be utilized by the quantum circuit 88. In some implementations, this information may be included in the request. In some implementations, the user 40 may indicate whether the quantum circuit 88 is to be executed on the quantum computing system 74-1 or the quantum computing system 74-2, and the quantum circuit controller pod 72 interacts with the designated quantum computing system 74 to cause the execution of the quantum circuit 88.

In other implementations, the quantum circuit controller pod 72 interacts with both the quantum computing system 74-1 and the quantum computing system 74-2 to determine which quantum computing system 74 could execute the quantum circuit 88 the soonest. In such implementation, the quantum circuit controller pod 72 invokes the QCS interface 78-1 of the quantum computing system 74-1 to obtain the QCD characteristics 80-1 and the QCD job queues 82-1 from the quantum computing system 74-1. The quantum circuit controller pod 72 also invokes the QCS interface 78-2 of the quantum computing system 74-2 to obtain the QCD characteristics 80-2 and the QCD job queues 82-2 from the quantum computing system 74-2.

The quantum circuit controller pod 72 may utilize the QCD characteristics 80-1, 80-2 and the QCD job queues 82-1, 82-2 to determine which quantum computing device 76-1-76-P, 84-1-84-Q implements sufficient qubits 32 to execute the quantum circuit 88, and has the smallest queue, and thus could execute the quantum circuit 88 soonest. In this example, assume that the quantum circuit controller pod 72 determines that the quantum computing device 84-1 in the quantum computing system 74-2 can execute the quantum circuit 88 soonest.

The quantum circuit control system 20-1 includes a plurality of job templates 96-1-96-2. The job template 96-1 corresponds to the quantum computing system 74-1 and contains a reference to a first QCS interface container image 97-1 that is configured to interface with the QCS interface 78-1, and the job template 96-2 corresponds to the quantum computing system 74-2 and contains a reference to a second QCS interface container image 97-2 that is configured to interface with the QCS interface 78-2. Because the selected quantum computing device 84-1 is part of the quantum computing system 74-2, the quantum circuit controller pod 72 modifies the job template 96-2 to include quantum circuit information that identifies the quantum circuit 88 and includes a quantum computing identifier that identifies the quantum computing device 84-1. The quantum circuit controller pod 72 initiates a job pod 98 from the job template 96-2. The job pod 98 initiates a quantum computing system interface container from the second QCS interface container image 97-2 and sends, to the quantum computing system 74-2, the quantum circuit information that identifies the quantum circuit 88 and instructions to execute the quantum circuit 88 on the selected quantum computing device 84-1. In some implementations, the quantum circuit information contains a reference to the location of the quantum circuit 88 and the bucket credentials associated with the quantum circuit 88. In other implementations, the quantum circuit information includes the quantum circuit 88.

In response to sending the quantum circuit information and the instructions to the quantum computing system 74-2, the job pod 98 receives, from the quantum computing system 74-2, initial job status metadata associated with the quantum circuit 88. The job pod 98 stores an initial job status record 100 that contains metadata from the initial job status metadata in the object store bucket 92 associated with the user 40. The job pod 98 terminates subsequent to storing the initial job status record 100 in the object store bucket 92.

Periodically, intermittently, and/or in accordance with a schedule, the quantum circuit control system 20-1 initiates a poller pod 102 that accesses object store buckets in the object storage 90, and for any unfinished quantum circuit jobs identified in such buckets, issues a request to the corresponding quantum computing system 74-1, 74-2 via the corresponding QCS interface 78-1, 78-2 for an updated job status. The corresponding quantum computing system 74-1, 74-2 receives the request(s) and provides, for each respective quantum circuit job, updated job status metadata. The poller pod 102 stores an updated job status record that contains metadata from the updated job status metadata in the appropriate object store bucket in lieu of any previous job status record, and then terminates.

Referring now to FIG. 3B, at a subsequent point in time, the quantum circuit control system 20-1 initiates a poller pod 104 that accesses the object store bucket 92. The poller pod 104 identifies the job status record 100 (FIG. 3A) and issues a request to the quantum computing system 74-2 via the QCS interface 78-2 for an updated job status. The quantum computing system 74-2 provides updated job status metadata that indicates that the quantum circuit 88 has completed, and that includes the results of the execution of the quantum circuit 88. The poller pod 104 generates and adds a job status record 106 to the object store bucket 92 that indicates that the quantum circuit 88 has completed and that contains the results of the execution of the quantum circuit 88.

The user 40 may subsequently access the QC IDE pod 86 and issue a quantum circuit status request to the quantum circuit control system 20-1 that requests a status of the execution of the quantum circuit 88. The quantum circuit controller pod 72 accesses the job status record 106 and provides the status and the results of the execution of the quantum circuit 88 to the user 40.

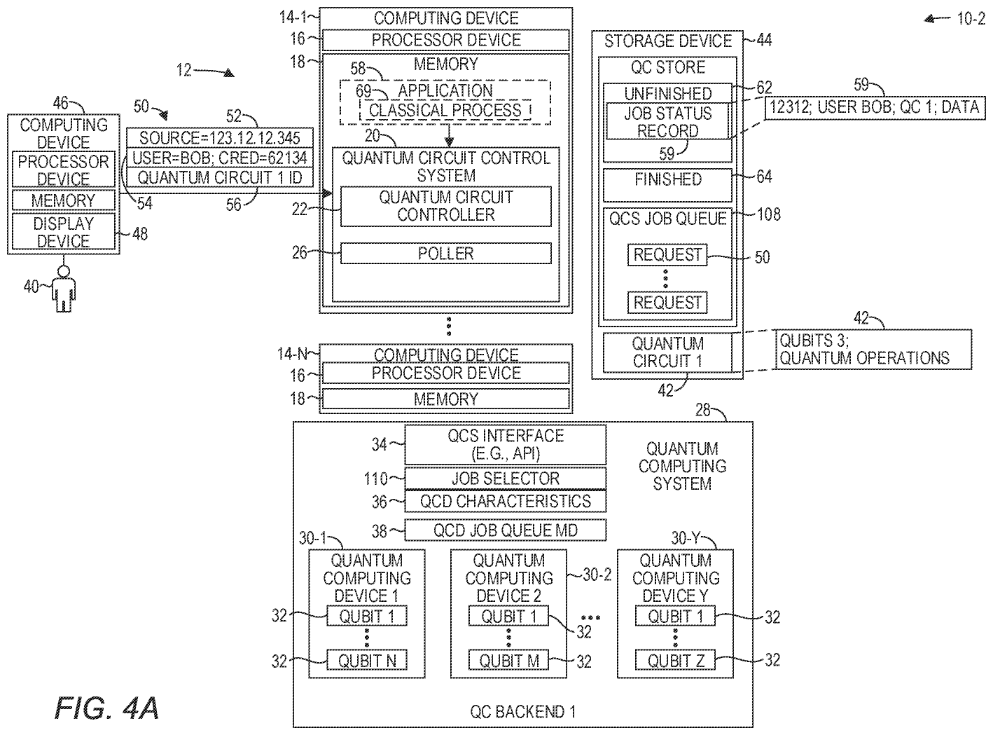

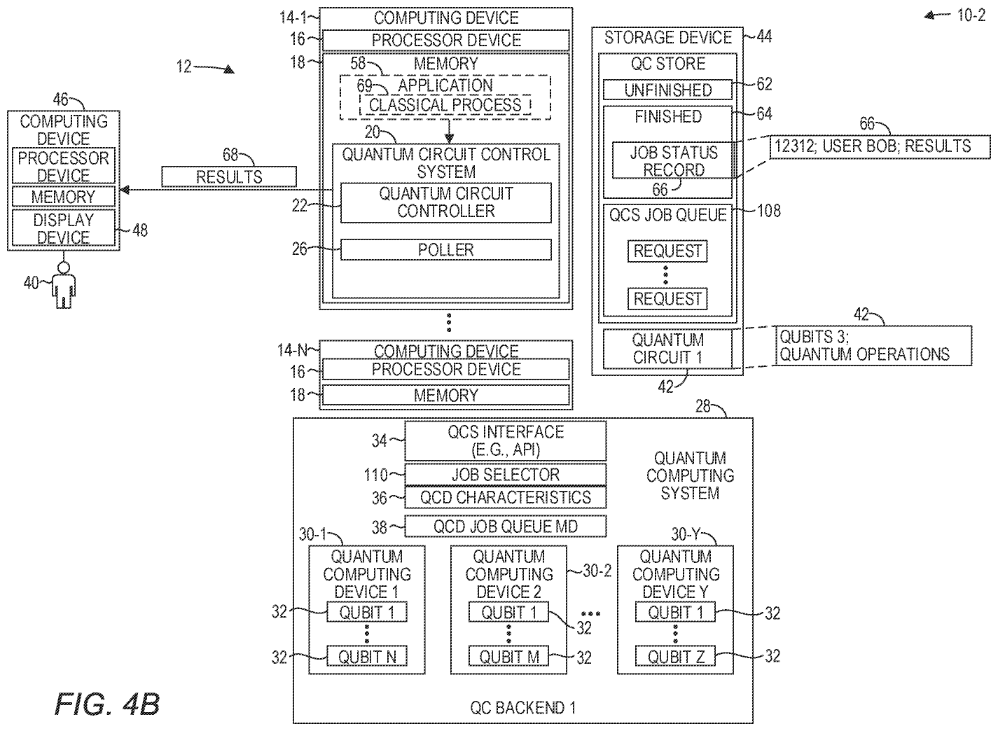

FIGS. 4A-4B are block diagrams of an environment 10-2 according to another implementation. The environment 10-2 is substantially similar to the environment 10 except as otherwise discussed herein. Referring first to FIG. 4A, in this implementation, the quantum circuit controller 22 receives the request 50 to execute the quantum circuit 42, which includes quantum program instructions that perform one or more quantum operations on one or more qubits. The quantum circuit controller 22 stores the request 50 in a QCS job queue 108. The quantum computing system 28 includes a job selector 110 which determines when a quantum computing device 30 becomes available to execute a quantum circuit. The job selector 110 accesses the QCS job queue 108 and analyzes the requests in the QCS job queue 108. The job selector 110 selects an oldest request that can be executed by the available quantum computing device 30. The job selector 110 obtains the corresponding quantum circuit 42 and provides the quantum circuit 42 to the available quantum computing device 30 for execution. The job selector 110 stores a job status record 59 in the unfinished bucket 62 that indicates that the quantum circuit 42 is in the process of being executed.

Referring now to FIG. 4B, when the quantum computing device 30 completes the execution of the quantum circuit 42, the job selector 110 deletes the job status record 59 (FIG. 4A) and adds a job status record 66 to the finished bucket 64. The job status record 66 may also include the results of the execution of the quantum circuit 42. In some implementations, the quantum circuit control system 20 may proactively send results 68 to the requestor that contains the results of the execution of the quantum circuit 42 so that the requestor obtains the results of the execution of the quantum circuit 42 in real time.

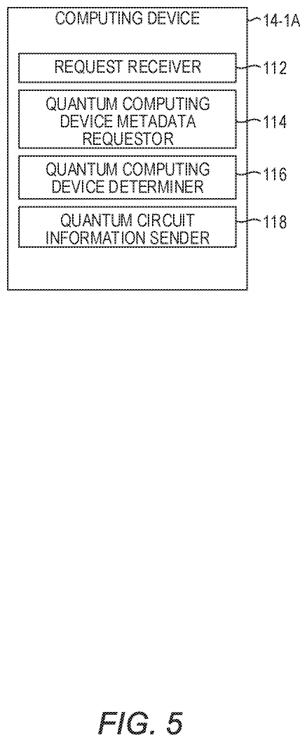

FIG. 5 is a block diagram of a computing device 14-1A according to another implementation. The computing device 14-1A implements identical functionality as that described above with regard to the computing device 14-1. The computing device 14-1A includes a request receiver 112 that is to receive a request to execute a quantum circuit that includes quantum program instructions that perform one or more quantum operations on one or more qubits.

The request receiver 112 may comprise executable software instructions to program a processor device to implement the functionality of receiving a request to execute a quantum circuit, may comprise circuitry including, by way of non-limiting example, an application-specific integrated circuit (ASIC), field-programmable gate array (FPGA), or may comprise a combination of executable software instructions and circuitry. In some implementations, the request receiver 112 may comprise a user interface via which a user can provide a request to execute a quantum circuit. In some implementations, the request receiver 112 may implement an API, such as, by way of non-limiting example, a REST API, via which a program can initiate a request to execute a quantum circuit.

The computing device 14-1A also includes a quantum computing device metadata requestor 114 that is to request, from a first quantum computing system comprising a first set of quantum computing devices, metadata describing characteristics of the first set of quantum computing devices. In some implementations, the quantum computing device metadata requestor 114 may utilize an API of the first quantum computing system to request the metadata describing characteristics of the first set of quantum computing devices. The quantum computing device metadata requestor 114 may comprise executable software instructions to program a processor device to implement the functionality of requesting, from a first quantum computing system comprising a first set of quantum computing devices, metadata describing characteristics of the first set of quantum computing devices, may comprise circuitry including, by way of non-limiting example, an ASIC, FPGA, or may comprise a combination of executable software instructions and circuitry.

The computing device 14-1A also includes a quantum computing device determiner 116 that is to determine, based on the quantum circuit and the metadata, a selected quantum computing device of the first set of quantum computing devices. The quantum computing device determiner 116 may comprise executable software instructions to program a processor device to implement the functionality of determining, based on the quantum circuit and the metadata, a selected quantum computing device of the first set of quantum computing devices, may comprise circuitry including, by way of non-limiting example, an ASIC, FPGA, or may comprise a combination of executable software instructions and circuitry. In some implementations, the quantum computing device determiner 116 may determine the selected quantum computing device based one or more criteria, such as, by way of non-limiting example, whether a quantum computing device has capabilities sufficient to execute the quantum circuit, and a quantity of queued quantum circuit jobs for each of the quantum computing devices in the first set of quantum computing devices.

The computing device 14-1A also includes a quantum circuit information sender 118 that is to send, to the first quantum computing system, quantum circuit information that identifies the quantum circuit and instructions to execute the quantum circuit on the selected quantum computing device. The quantum circuit information sender 118 may comprise executable software instructions to program a processor device to implement the functionality of sending, to the first quantum computing system, quantum circuit information that identifies the quantum circuit and instructions to execute the quantum circuit on the selected quantum computing device, may comprise circuitry including, by way of non-limiting example, an ASIC, FPGA, or may comprise a combination of executable software instructions and circuitry. The quantum circuit information sender 118 may send the quantum circuit information, for example, by invoking a method of an API of the first quantum computing system, or may utilize any other inter-process communications mechanism that allows processes executing on different computing devices to communicate with one another.

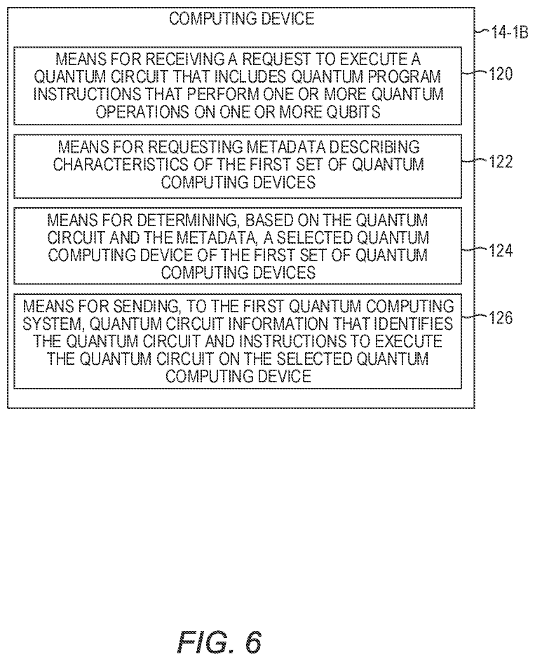

FIG. 6 is a block diagram of a computing device 14-1B according to additional implementations. The computing device 14-1B implements identical functionality as that described above with regard to the computing device 14-1. In this implementation, the computing device 14-1B includes a means 120 for receiving, by a classical computing system comprising one or more classical computing devices comprising one or more processor devices, a request to execute a quantum circuit that includes quantum program instructions that perform one or more quantum operations on one or more qubits. The means 120 may be implemented in any number of manners, including, for example, via the request receiver 112 illustrated in FIG. 5.

The computing device 14-1B also includes a means 122 for requesting, by the classical computing system from a first quantum computing system comprising a first set of quantum computing devices, metadata describing characteristics of the first set of quantum computing devices. The means 122 may be implemented in any number of manners, including, for example, via the quantum computing device metadata requestor 114 illustrated in FIG. 5.

The computing device 14-1B also includes a means 124 for determining, by the classical computing system, based on the quantum circuit and the metadata, a selected quantum computing device of the first set of quantum computing devices. The means 124 may be implemented in any number of manners, including, for example, via the quantum computing device determiner 116 illustrated in FIG. 5.

The computing device 14-1B also includes a means 126 for sending, to the first quantum computing system, quantum circuit information that identifies the quantum circuit and instructions to execute the quantum circuit on the selected quantum computing device. The means 126 may be implemented in any number of manners, including, for example, via the quantum circuit information sender 118 illustrated in FIG. 5.

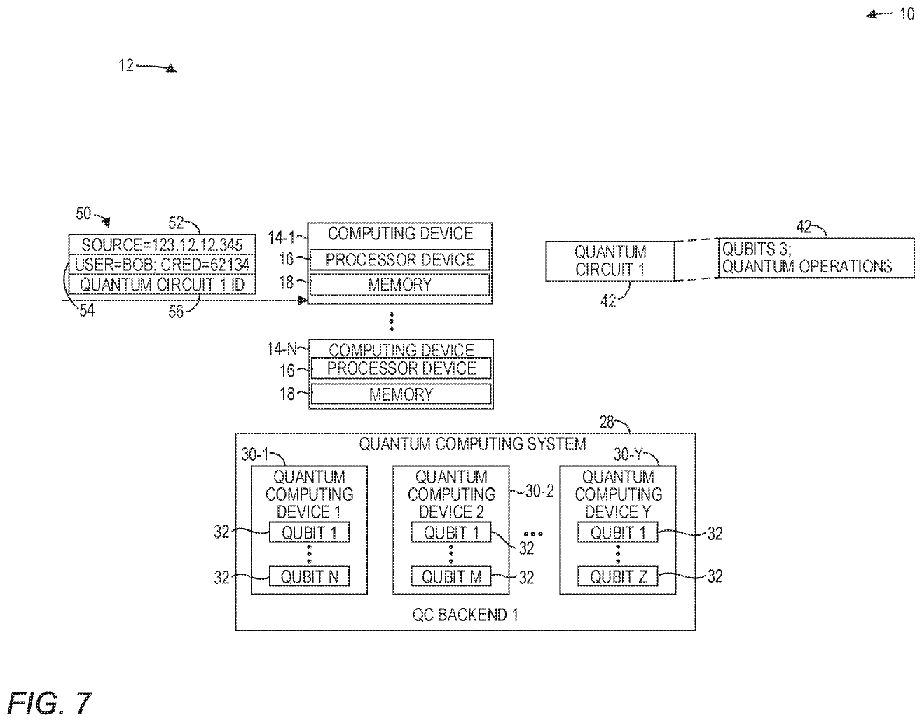

FIG. 7 is a simplified block diagram of the environment 10 illustrated in FIGS. 1A-1B according to one implementation. The environment 10 includes the computing system 12 that includes the one or more classical computing devices 14, which each include one or more processor devices 16. The one or more processor devices 16 are to receive the request 50 to execute the quantum circuit 42 that includes the quantum program instructions that perform one or more quantum operations on one or more qubits 32. The one or more processor devices 16 are further to request, from the first quantum computing system 28 comprising the first set of quantum computing devices 30, metadata describing characteristics of the first set of quantum computing devices 30. The one or more processor devices 16 are further to determine, based on the quantum circuit 42 and the metadata, a selected quantum computing device 30 of the first set of quantum computing devices 30. The one or more processor devices 16 are further to send, to the first quantum computing system 30, quantum circuit information that identifies the quantum circuit 42 and instructions to execute the quantum circuit 42 on the selected quantum computing device 30.

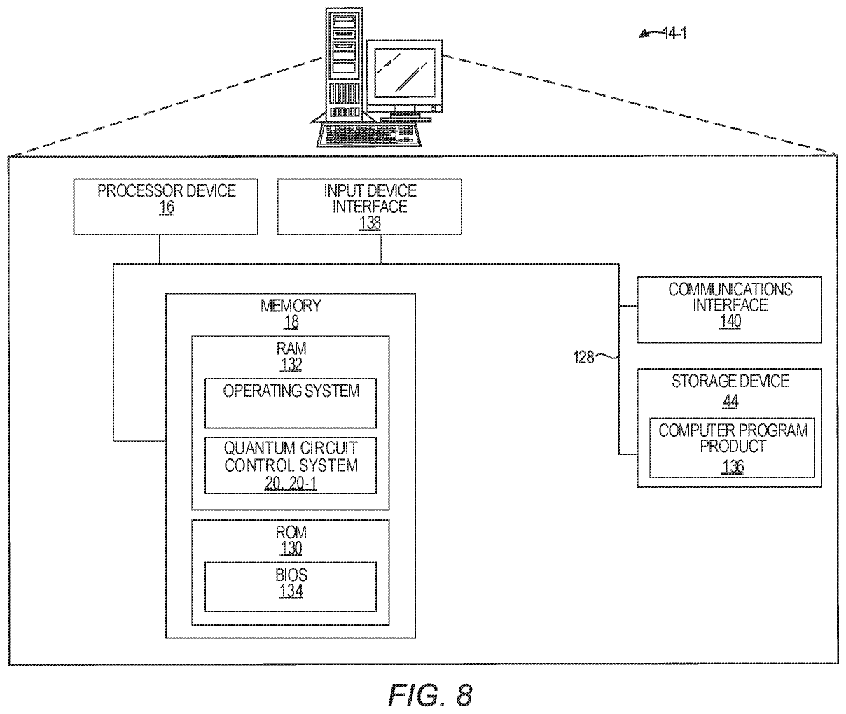

FIG. 8 is a block diagram of the computing device 14-1 suitable for implementing examples according to one example. The computing device 14-1 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 14-1 includes the processor device 16, the memory 18, and a system bus 128. The system bus 128 provides an interface for system components including, but not limited to, the memory 18 and the processor device 16. The processor device 16 can be any commercially available or proprietary processor.

The system bus 128 may be any of several types of bus structures that may further interconnect to a memory bus (with or without a memory controller), a peripheral bus, and/or a local bus using any of a variety of commercially available bus architectures. The memory 18 may include non-volatile memory 130 (e.g., read-only memory (ROM), erasable programmable read-only memory (EPROM), electrically erasable programmable read-only memory (EEPROM), etc.), and volatile memory 132 (e.g., random-access memory (RAM)). A basic input/output system (BIOS) 134 may be stored in the non-volatile memory 130 and can include the basic routines that help to transfer information between elements within the computing device 14-1. The volatile memory 132 may also include a high-speed RAM, such as static RAM, for caching data.

The computing device 14-1 may further include or be coupled to a non-transitory computer-readable storage medium such as the storage device 44, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 44 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 44 and in the volatile memory 132, including an operating system and one or more program modules, such as the quantum circuit control systems 20, 20-1, which may implement the functionality described herein in whole or in part.

All or a portion of the examples may be implemented as a computer program product 136 stored on a transitory or non-transitory computer-usable or computer-readable storage medium, such as the storage device 44, which includes complex programming instructions, such as complex computer-readable program code, to cause the processor device 16 to carry out the steps described herein.

An operator may also be able to enter one or more configuration commands through a keyboard (not illustrated), a pointing device such as a mouse (not illustrated), or a touch-sensitive surface such as a display device. Such input devices may be connected to the processor device 16 through an input device interface 138 that is coupled to the system bus 128 but can be connected by other interfaces such as a parallel port, an Institute of Electrical and Electronic Engineers (IEEE) 1394 serial port, a Universal Serial Bus (USB) port, an IR interface, and the like. The computing device 14-1 may also include a communications interface 140 suitable for communicating with a network as appropriate or desired.

Other computer system designs and configurations may also be suitable to implement the systems and methods described herein. The following examples illustrate various additional implementations in accordance with one or more aspects of the disclosure.

Example 1 is a computing device that includes a means for receiving, by a classical computing system including one or more classical computing devices including one or more processor devices, a request to execute a quantum circuit that includes quantum program instructions that perform one or more quantum operations on one or more qubits; a means for requesting, by the classical computing system from a first quantum computing system including a first set of quantum computing devices, metadata describing characteristics of the first set of quantum computing devices; a means for determining, by the classical computing system, based on the quantum circuit and the metadata, a selected quantum computing device of the first set of quantum computing devices; and a means for sending, to the first quantum computing system, quantum circuit information that identifies the quantum circuit and instructions to execute the quantum circuit on the selected quantum computing device.

Example 2 is a computing device that includes a request receiver that is to receive a request to execute a quantum circuit that includes quantum program instructions that perform one or more quantum operations on one or more qubits; a quantum computing device metadata requestor that is to request, from a first quantum computing system including a first set of quantum computing devices, metadata describing characteristics of the first set of quantum computing devices; a quantum computing device determiner that is to determine, based on the quantum circuit and the metadata, a selected quantum computing device of the first set of quantum computing devices; and a quantum circuit information sender that is to send, to the first quantum computing system, quantum circuit information that identifies the quantum circuit and instructions to execute the quantum circuit on the selected quantum computing device.

Example 3 is a method that includes receiving, by a quantum circuit controller pod of a quantum circuit control system in a container orchestration system, a request to execute a quantum circuit that performs quantum operations on one or more qubits; requesting, by the quantum circuit controller pod from a quantum computing system comprising a first set of quantum computing devices, metadata describing characteristics of the first set of quantum computing devices; determining, by the quantum circuit controller pod, based on the quantum circuit and the metadata, a selected quantum computing device of the first set of quantum computing devices; accessing, by the quantum circuit controller pod, a job template that comprises a reference to a quantum computing system interface container image that is configured to communicate with the quantum computing system; modifying the job template to include quantum circuit information that identifies the quantum circuit and to include a quantum computing identifier that identifies the selected quantum computing device; initiating a pod from the job template, the pod including at least one quantum computing system interface container initiated from the quantum computing system interface container image; and sending, by the quantum computing system interface container to the quantum computing system, the quantum circuit information that identifies the quantum circuit and instructions to execute the quantum circuit on the selected quantum computing device.

Example 4 is the method of example 3 further including, in response to sending the quantum circuit information and the instructions to the quantum computing system, receiving, by the pod from the quantum computing system, initial job status metadata associated with the quantum circuit; storing, by the pod, an initial job status record that contains metadata from the initial job status metadata in a storage device; and wherein the pod terminates immediately subsequent to storing the initial job status record in the storage device.

Example 5 is the method of example 4 further including, subsequent to receiving the initial job status metadata, initiating a status update pod of the quantum circuit control system; accessing, by the status update pod, the storage device to determine a set of unfinished quantum circuit jobs, each unfinished quantum circuit job corresponding to a job status record that corresponds to a quantum circuit executing or scheduled to be executed on a quantum computing device of the quantum computing system; and for each respective unfinished quantum circuit job in the set of unfinished quantum circuit jobs: requesting, from the quantum computing system, an updated job status of the corresponding quantum circuit; and storing, in the storage device, an updated job status record.

Example 6 is the method of example 5 further including determining, by the status update pod, that an updated job status corresponding to a first quantum circuit indicates that the first quantum circuit has completed; deleting a job status record that corresponds to the first quantum circuit from an unfinished storage bucket; and adding a job status record that corresponds to the first quantum circuit to a finished storage bucket.

Example 7 is the method of example 3 wherein receiving the request to execute the quantum circuit includes receiving, by the quantum circuit controller pod from a quantum circuit editor pod, the request to execute the quantum circuit.

Example 8 is the method of example 3 wherein the quantum circuit is defined in a Jupyter notebook.

Example 9 is the method of example 3 wherein the container orchestration system comprises a Kubernetes container orchestration system.

Example 10 is a computing system including one or more classical computing devices comprising one or more processor devices, wherein the one or more classical computing devices are to: receive, by a quantum circuit controller pod of a quantum circuit control system in a container orchestration system executing on the one or more classical computing devices, a request to execute a quantum circuit that performs quantum operations on one or more qubits; request, by the quantum circuit controller pod from a quantum computing system comprising a first set of quantum computing devices, metadata describing characteristics of the first set of quantum computing devices; determine, by the classical computing system, based on the quantum circuit and the metadata, a selected quantum computing device of the first set of quantum computing devices; access a job template that comprises a reference to a quantum computing system interface container image that is configured to communicate with the quantum computing system; modify the job template to include quantum circuit information that identifies the quantum circuit and to include a quantum computing identifier that identifies the selected quantum computing device; initiate a pod from the job template, the pod including at least one quantum computing system interface container initiated from the quantum computing system interface container image; and send, by the quantum computing system interface container to the quantum computing system, the quantum circuit information that identifies the quantum circuit and instructions to execute the quantum circuit on the selected quantum computing device.

Example 11 is a method that includes receiving, by a quantum circuit controller pod of a quantum circuit controller system in a Kubernetes container orchestration system, a request to execute a quantum circuit that performs quantum operations on one or more qubits; requesting, by the quantum circuit controller pod from a first quantum computing system comprising a first set of quantum computing devices, metadata describing characteristics of the first set of quantum computing devices, and from a second quantum computing system comprising a second set of quantum computing devices, metadata describing characteristics of the second set of quantum computing devices; determining, by the quantum circuit controller pod, based on the quantum circuit, the first metadata, and the second metadata, a selected quantum computing device of the first set of quantum computing devices; accessing a job template that comprises a reference to a quantum computing system interface container image that is configured to communicate with the first quantum computing system; modifying the job template to include quantum circuit information that identifies the quantum circuit and to include a quantum computing identifier that identifies the selected quantum computing device; initiating a pod from the job template, the pod including at least one quantum computing system interface container initiated from the quantum computing system interface container image; and sending, by the quantum computing system interface container to the first quantum computing system, the quantum circuit information that identifies the quantum circuit and instructions to execute the quantum circuit on the selected quantum computing device.

Example 12 is a method that includes receiving, by a quantum circuit controller pod of a quantum circuit controller system in a container orchestration system, a request to execute a quantum circuit that performs quantum operations on one or more qubits; storing, in a storage device, a quantum circuit record that comprises the quantum circuit; accessing, by a first quantum computing system comprising a first set of quantum computing devices, the quantum circuit record; determining, by the first quantum computing system, that a first quantum computing device of the first set of quantum computing devices is available to execute the quantum circuit; and storing, by the first quantum computing system, information in the storage device in conjunction with the quantum circuit record that indicates that the quantum circuit is being executed by the first quantum computing device.

Example 13 is the method of example 12 further including determining, by the first quantum computing system, that the quantum circuit has completed; and storing, by the first quantum computing system in the storage device, information that indicates that the quantum circuit has completed, and execution results from the quantum circuit.

Example 14 is the method of claim 13 further including accessing, by the quantum circuit controller pod, the storage device; determining, by the quantum circuit controller pod, that the quantum circuit has completed; and sending the execution results to a requestor associated with the request.

Example 15 is a system that includes a classical computing system including one or more classical computing devices including one or more processor devices; and a first quantum computing system including a set of quantum computing devices; wherein the classical computing system is to: receive a request to execute a quantum circuit that includes quantum program instructions that perform one or more quantum operations on one or more qubits; request, from the first quantum computing system, metadata describing characteristics of the first set of quantum computing devices; determine, by the classical computing system, based on the quantum circuit and the metadata, a selected quantum computing device of the first set of quantum computing devices; and send, to the first quantum computing system, quantum circuit information that identifies the quantum circuit and instructions to execute the quantum circuit on the selected quantum computing device; and wherein the first quantum computing system is to, in response to receiving the quantum circuit information and the instructions, send, to the classical computing system, initial job status metadata associated with the quantum circuit.

Individuals will recognize improvements and modifications to the preferred examples of the disclosure. All such improvements and modifications are considered within the scope of the concepts disclosed herein and the claims that follow.

What is claimed is:

1. A method comprising:
receiving, by a classical computing system comprising one or more classical computing devices comprising one or more processor devices, a request to execute a quantum circuit that includes quantum program instructions that perform one or more quantum operations on one or more qubits;
requesting, by the classical computing system from a first quantum computing system comprising a first set of quantum computing devices, metadata describing characteristics of the first set of quantum computing devices;
determining, by the classical computing system, based on the quantum circuit and the metadata, a selected quantum computing device of the first set of quantum computing devices; and
sending, to the first quantum computing system, quantum circuit information that identifies the quantum circuit and instructions to execute the quantum circuit on the selected quantum computing device.

2. The method of claim 1 further comprising:
in response to sending the quantum circuit information and the instructions to the first quantum computing system, receiving, by the classical computing system from the first quantum computing system, initial job status metadata associated with the quantum circuit; and
storing, by the classical computing system, an initial job status record that contains metadata from the initial job status metadata in a storage device.

3. The method of claim 2 further comprising:
subsequent to receiving the initial job status metadata, requesting, by the classical computing system from the first quantum computing system, an updated job status associated with the quantum circuit;
receiving, by the classical computing system, updated job status metadata associated with the quantum circuit; and
storing, by the classical computing system, an updated job status record that contains metadata from the updated job status metadata in the storage device.

4. The method of claim 3 further comprising iteratively requesting, by the classical computing system from the first quantum computing system, the updated job status associated with the quantum circuit until the first quantum computing system indicates that the quantum circuit has completed.

5. The method of claim 3 wherein the updated job status indicates that the quantum circuit has completed, and further comprising:
deleting a job status record that corresponds to the quantum circuit from an unfinished bucket in the storage device; and
adding a job status record that corresponds to the quantum circuit to a finished bucket in the storage device.

6. The method of claim 3 wherein the updated job status record indicates that the quantum circuit has completed, and further comprising sending information indicating that the quantum circuit has completed to a requestor associated with the request.

7. The method of claim 2 further comprising:
receiving, by the classical computing system from a requestor associated with the request, a quantum circuit status request;
accessing, by the classical computing system, the storage device to determine a job status record that corresponds to the quantum circuit; and
sending, to the requestor, information that identifies a job status of the quantum circuit based on the job status record that corresponds to the quantum circuit.

8. The method of claim 1 further comprising:
receiving, by the classical computing system, credentials associated with the request, the credentials comprising data that authenticates a requestor associated with the request with the first quantum computing system; and
providing, by the classical computing system to the first quantum computing system, the credentials in conjunction with the quantum circuit information and the instructions.

9. The method of claim 1 further comprising:
analyzing, by the classical computing system, the quantum circuit to determine a number of qubits utilized by the quantum circuit; and
wherein determining, based on the quantum circuit and the metadata, the selected quantum computing device of the first set of quantum computing devices includes:
determining that the selected quantum computing device implements a quantity of qubits equal to or greater than the number of qubits utilized by the quantum circuit.

10. The method of claim 9 wherein the metadata identifies, for each respective quantum computing device in the first set of quantum computing devices, a number of qubits implemented by the respective quantum computing device.

11. The method of claim 1 wherein determining, based on the quantum circuit and the metadata, the selected quantum computing device of the first set of quantum computing devices comprises:
determining, based on the metadata, a number of quantum circuit jobs queued to be executed by the selected quantum computing device; and
determining that the number of quantum circuit jobs queued to be executed by the selected quantum computing device is less than a number of quantum circuit jobs queued to be executed by one or more other quantum computing devices of the first quantum computing system.

12. The method of claim 11 wherein the metadata identifies, for each respective quantum computing device in the first set of quantum computing devices, a number of quantum circuit jobs queued to be executed by the respective quantum computing device.

13. The method of claim 1 wherein:
requesting the metadata describing the characteristics of the first set of quantum computing devices further comprises:
invoking a method of an application programming interface of the first quantum computing system that is configured to, when invoked, return the metadata describing the characteristics of the first set of quantum computing devices.

14. The method of claim 1 further comprising:
requesting, by the classical computing system from a second quantum computing system comprising a second set of quantum computing devices, second metadata describing characteristics of the second set of quantum computing devices; and
wherein determining, by the classical computing system, based on the quantum circuit and the metadata, the selected quantum computing device of the first set of quantum computing devices further comprises:
determining, by the classical computing system, based on the quantum circuit, the metadata, and the second metadata, the selected quantum computing device.

15. The method of claim 1 wherein:
receiving, by the classical computing system, the request to execute the quantum circuit that includes the quantum program instructions that perform the one or more quantum operations on the one or more qubits further comprises:
receiving, by a quantum circuit control system executing on the classical computing system from an application, the request;
determining, by the quantum circuit control system, that the quantum circuit has completed;
obtaining, by the quantum circuit control system, results of the execution of the quantum circuit; and
sending, by the quantum circuit control system to the application, the results of the execution of the quantum circuit.

16. The method of claim 1 wherein the quantum circuit information comprises the quantum circuit.

17. The method of claim 1 wherein the quantum circuit information comprises a reference to a location of the quantum circuit.

18. A computing system comprising:
one or more classical computing devices comprising one or more processor devices;
the one or more processor devices to:
receive a request to execute a quantum circuit that includes quantum program instructions that perform one or more quantum operations on one or more qubits;
request, from a first quantum computing system comprising a first set of quantum computing devices, metadata describing characteristics of the first set of quantum computing devices;
determine, based on the quantum circuit and the metadata, a selected quantum computing device of the first set of quantum computing devices; and
send, to the first quantum computing system, quantum circuit information that identifies the quantum circuit and instructions to execute the quantum circuit on the selected quantum computing device.

19. The computing system of claim 18 wherein the one or more processor devices are further to:
subsequent to receiving the initial job status metadata, request, from the first quantum computing system, an updated job status associated with the quantum circuit;
receive updated job status metadata associated with the quantum circuit; and
store an updated job status record that contains metadata from the updated job status metadata in the storage device.

20. A non-transitory computer-readable storage medium that includes executable instructions to cause one or more processor devices to:
receive a request to execute a quantum circuit that includes quantum program instructions that perform one or more quantum operations on one or more qubits;
request, from a first quantum computing system comprising a first set of quantum computing devices, metadata describing characteristics of the first set of quantum computing devices;
determine, based on the quantum circuit and the metadata, a selected quantum computing device of the first set of quantum computing devices; and
send, to the first quantum computing system, quantum circuit information that identifies the quantum circuit and instructions to execute the quantum circuit on the selected quantum computing device.
